(19) United States
(12) Patent Application Publication
(10) Pub. No.: US 2016/0000099 A1
(43) Pub. Date: Jan. 7, 2016

(54) MONOLAYER FOOD PRODUCT AND METHODS

(71) Applicant: Wm. Bolthouse Farms, Inc., Bakersfield, CA (US)

(72) Inventors: Joseph Phillip DeStephano, Bakersfield, CA (US); Tanuj Motwani, Bakersfield, CA (US); Tori Lyn O'Neal, Bakersfield, CA (US); Patrick Harold Figueroa-McKendry, Bakersfield, CA (US); Cecilia Colin, Bakersfield, CA (US); Jason Edward Chua Bernardo, Bakersfield, CA (US)

(21) Appl. No.: 14/725,753

(22) Filed: May 29, 2015

Related U.S. Application Data
(60) Provisional application No. 62/006,591, filed on Jun. 2, 2014.

(51) Int. Cl. A23B 7/005; B65D 81/34

(52) U.S. Cl. CPC A23B 7/005; B65D 81/34

(57) ABSTRACT

Embodiments of the invention include food products and related methods. In an embodiment, the invention includes a method for producing a food product. The method can include arranging one or more discrete pieces of a food material into a monolayer inside a pouch, sealing the pouch, and exposing the sealed pouch to a sterilization or pasteurization cycle effective to reduce the number of viable microorganisms and/or their spores in the food product. The food product can include a pouch comprising a front wall and a back wall, the front wall and the back wall attached to one another and defining an interior volume. The food product can further include a food material disposed within the interior volume, the food material comprising one or more discrete pieces of a food material, the discrete pieces arranged in a monolayer between the front wall and the back wall. The discrete pieces can have a thickness, wherein the thickness is greater than or equal to 0.25 inches and less than or equal to 1.25 inches.

This application claims the benefit of U.S. Provisional Application No. 62/006,591, filed Jun. 2, 2014, the content of which is herein incorporated by reference in its entirety.

### FIELD OF THE INVENTION

The present invention relates to food products and related methods. More specifically, the present invention relates to food products arranged in a monolayer.

### BACKGROUND OF THE INVENTION

Because most foods have a tendency to spoil relatively quickly, food preservation techniques have been developed over many years to extend the amount of time that a given food product will remain fresh. Food preservation techniques can include drying, freezing, fermenting, pickling, curing, canning, heat treating, irradiating, adding preservative agents and the like.

While food preservation techniques have been successful at extending the time until food spoils, it has been found that various food preservation techniques can have adverse effects on food products including, diminishing the taste and appearance of the food, reducing nutritional qualities of the food, adding calories, and the like.

### SUMMARY OF THE INVENTION

Embodiments of the invention include food products and related methods. In an embodiment, the invention includes a method for producing a food product. The method can include arranging one or more discrete pieces of a food material into a monolayer inside a pouch, sealing the pouch, and exposing the sealed pouch to a sterilization or pasteurization cycle effective to reduce the number of viable microorganisms and/or their spores in the food product.

In an embodiment, the invention includes a food product. The food product can include a pouch comprising a front wall and a back wall, the front wall and the back wall attached to one another and defining an interior volume. The food product can further include a food material disposed within the interior volume, the food material comprising one or more discrete pieces of a food material, the pieces arranged in a monolayer between the front wall and the back wall. The pieces can have a thickness, wherein the thickness is greater than or equal to 0.25 inches and less than or equal to 1.25 inches; and the food material comprising a plant or animal food material.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present invention is defined by the appended claims and their legal equivalents.

### BRIEF DESCRIPTION OF THE FIGURES

The invention may be more completely understood in connection with the following drawings, in which:

FIG. 1 is a schematic front view of a monolayer food product in accordance with various embodiments herein.

FIG. 2 is a schematic cross-sectional view of a monolayer food product as taken along line A-A′ of FIG. 1.

FIG. 3 is a schematic cross-sectional view of a monolayer food product in accordance with various embodiments herein.

FIG. 4 is a schematic cross-sectional view of a monolayer food product in accordance with various embodiments herein.

FIG. 5 is a schematic front view of a monolayer food product in accordance with various embodiments herein.

FIG. 6 is a schematic front view of a monolayer food product in accordance with various embodiments herein.

FIG. 7 is a schematic front view of a monolayer food product in accordance with various embodiments herein.

FIG. 8 is a schematic cross-sectional view of a water absorbent accessory in accordance with various embodiments herein.

FIG. 9 is a schematic front view of a monolayer food product in accordance with various embodiments herein.

FIG. 10 is a schematic front view of a monolayer food product in accordance with various embodiments herein.

FIG. 11 is a flow chart of a method in accordance with various embodiments herein.

FIG. 12 is a flow chart of a method in accordance with various embodiments herein.

FIG. 13 is a flow chart of a method in accordance with various embodiments herein.

FIG. 14 is a flow chart of a method in accordance with various embodiments herein.

FIG. 15 is a flow chart of a method in accordance with various embodiments herein.

FIG. 16 is a schematic front view of a monolayer food product in accordance with various embodiments herein.

FIG. 17 is a graph of temperature versus time for carrot pieces arranged in a monolayer.

FIG. 18 is a graph of temperature versus time for pear pieces arranged in a monolayer.

While the invention is susceptible to various modifications and alternative forms, specifics thereof have been shown by way of example and drawings, and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION OF THE INVENTION

The embodiments of the present invention described herein are not intended to be exhaustive or to limit the invention to the precise forms disclosed in the following detailed description. Rather, the embodiments are chosen and described so that others skilled in the art can appreciate and understand the principles and practices of the present invention.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

As described above, while food preservation techniques have been successful at extending the time until food spoils, it has been found that various food preservation techniques can have adverse effects. By way of example, heat treatments can be quite effective at preserving food products, however, exposure to heat can diminish taste, texture, nutritional value, appearance and the like. Particularly in the case of fresh vegetables and fruits, taste, appearance and texture can be unacceptably reduced in quality.

The applicants herein have found that by arranging pieces of a food product as a monolayer within a package, an effective amount of a microorganism killing treatment can be applied, while minimizing the adverse impact on taste, appearance and texture.

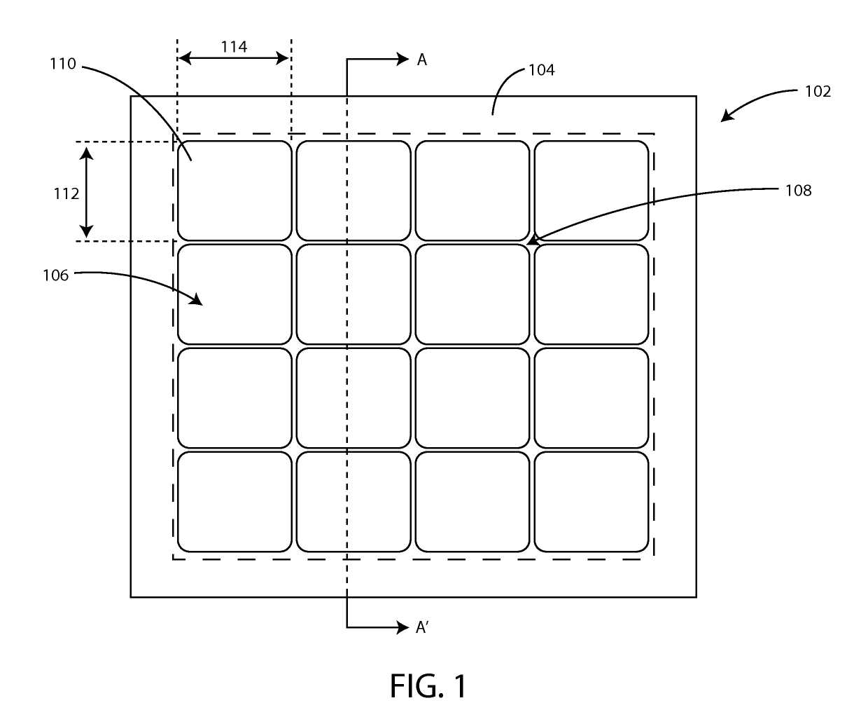

Referring now to FIG. 1, the food product 102 includes a pouch 104 and a food material 106. The pouch 104 defines an interior volume 108 in which the food material is disposed. The food material 106 includes a plurality of discrete pieces 110 (or large particulates). The plurality of discrete pieces 110 each include a height 112 and a width 114.

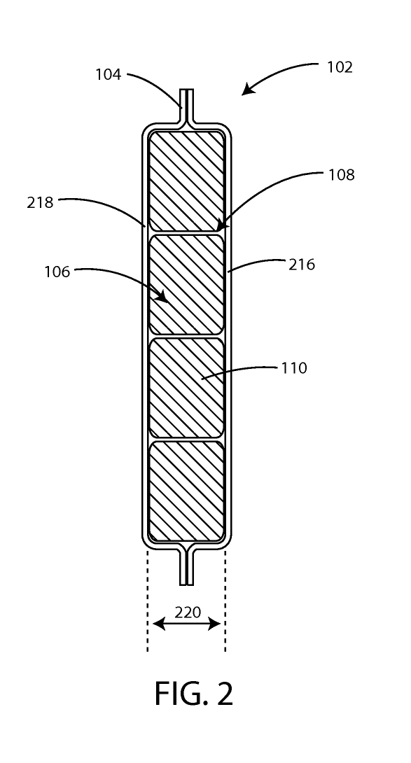

Referring now to FIG. 2, a schematic cross-sectional view of the food product 102 is shown as taken along line A-A′ of FIG. 1. The food product 102 includes a pouch 104 and a food material 106. The pouch 104 includes a front wall 216, a back wall 218, which together define an interior volume 108. The food material 106 includes a plurality of discrete pieces 110. The plurality of discrete pieces 110 includes a thickness 220.

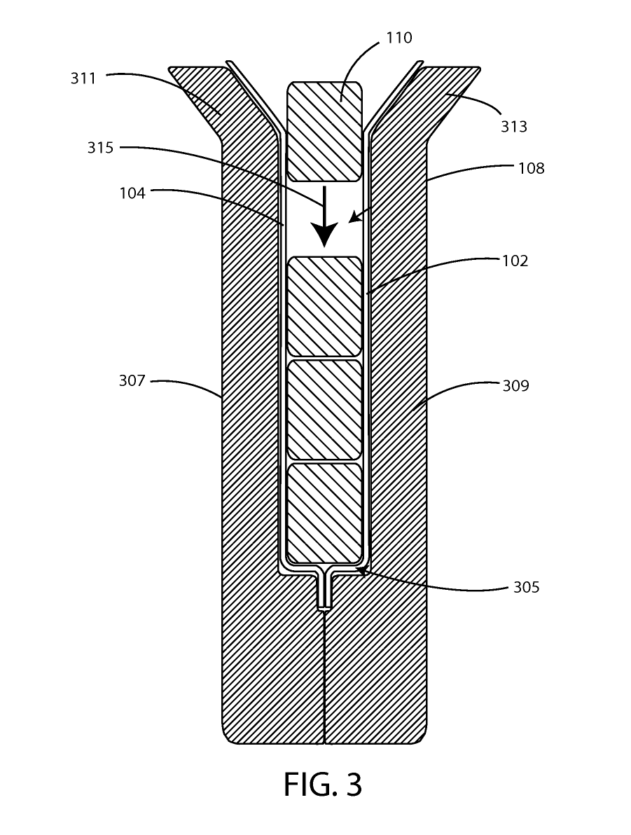

While it will be appreciated that there are many ways in which pieces of a food product can be arranged into a monolayer, in some embodiments the package or pouch can be placed within a cavity in order to assist with the process of arranging the food product pieces. Referring now to FIG. 3, the food product 102 includes a pouch 104 and a food material 106. The pouch 104 includes a front wall 216, a back wall 218, and an interior volume 108. The food material 106 includes a plurality of discrete pieces 110. The pouch 104 can be placed within a rigid cavity 305. The rigid cavity 305 can be formed in various ways. In some embodiments, the rigid cavity 305 can be formed with a first rigid piece 307 and a second rigid piece 309. As the size of the pieces is nearly the size as the width of the rigid cavity 305, the pieces form a monolayer as they are inserted into the pouch 104 in the direction of arrow 315. In some embodiments, the component(s) forming the cavity can include a flange 311, 313 (or funnel) near their top in order to form a structure that can guide pieces of the food product into the interior volume 108 of the pouch 104. In other embodiments, the cavity can be formed with a single component.

Other techniques for arranging pieces of a food product as a monolayer can include depositing the pieces on a top of a first wall (or side) of the pouch then placing the second wall (or side) over the food products and then attaching the first wall to the second wall along the peripheral edges to seal the two walls or sides to one another.

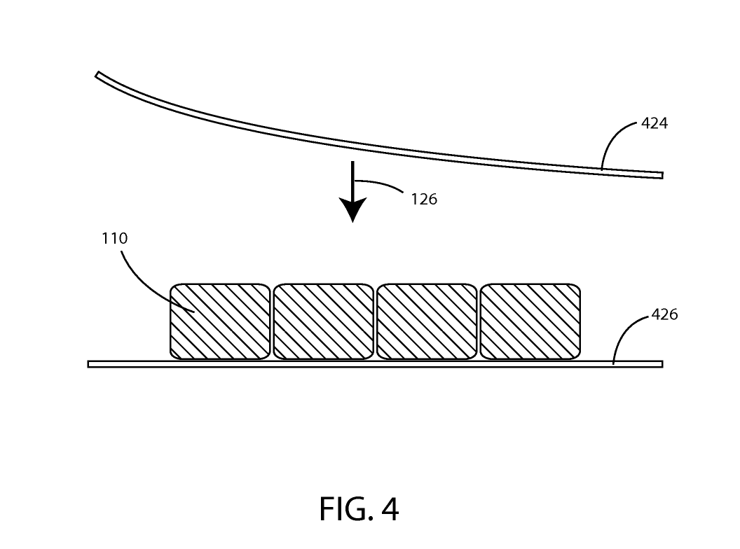

Referring now to FIG. 4, one example this approach is illustrated. The food product 102 includes a first wall 424 and a second wall 426. The food material includes a plurality of discrete pieces 110. The food product can be formed by placing the discrete pieces 110 onto the first wall 424 as a monolayer and then placing the second wall 426 onto the discrete pieces 110 as indicated by arrow 126. After the second wall 426 is in position over the discrete pieces, then the first wall 424 and the second wall 426 can be sealed to one another around their peripheries. Various techniques can be used including thermal sealing, ultrasonic welding, adhesive based sealing, and the like. In various embodiments, vacuum pressure can be applied to the food product before and/or during the sealing process.

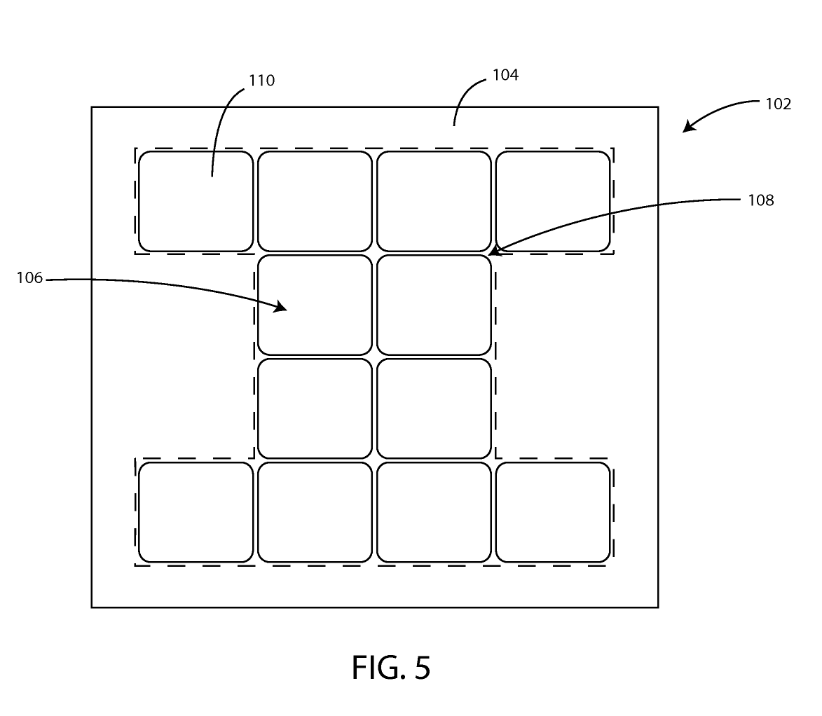

It will be appreciated that while being arranged as a monolayer, the pieces of the food product can be arranged in various ways as viewed from the front of the package. In some embodiments, the plurality of pieces wherein the pieces of food can be arranged in a square or a rectangle as viewed from the side. In other embodiments, the pieces of food can be arranged to form other shapes as viewed from the side. By way of example, referring now to FIG. 5, the food product 102 includes a pouch 104 and a food material 106. The pouch 104 includes an interior volume 108. The food material 106 includes a plurality of pieces 110. In this example, the pieces 110 are arranged in an “I” configuration. Many other configurations are also contemplated herein.

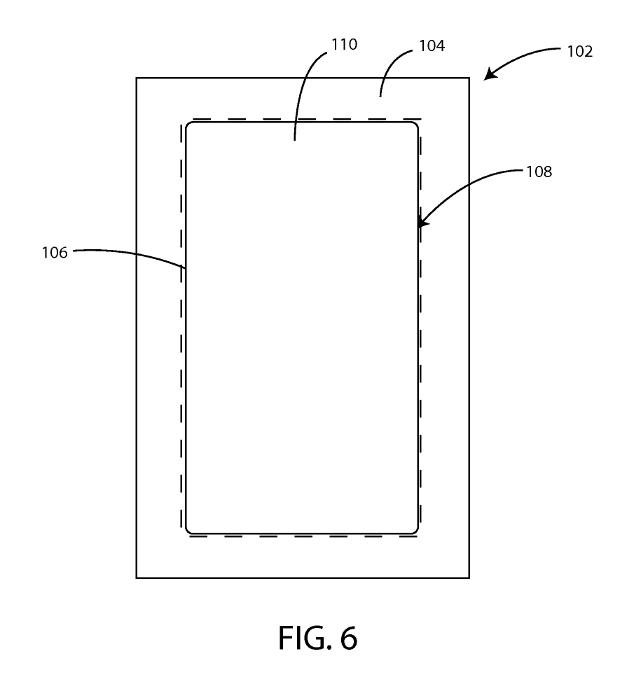

Various numbers of discrete pieces of the food material can be used. In some embodiments, there are one or more discrete pieces. In some embodiments, the number of discrete pieces is from 1 to 1000. In some embodiments, the number of discrete pieces is from 1 to 100. In some embodiments, the number of discrete pieces is from 2 to 40. In some embodiments, the number of discrete pieces is from 4 to 30. Referring now to FIG. 6, the food product 102 includes a pouch 104 and a food material 106. The pouch 104 includes an interior volume 108. In this embodiment, the food material 106 includes a single piece 110. In this embodiment, the height and width are substantially greater than the thickness.

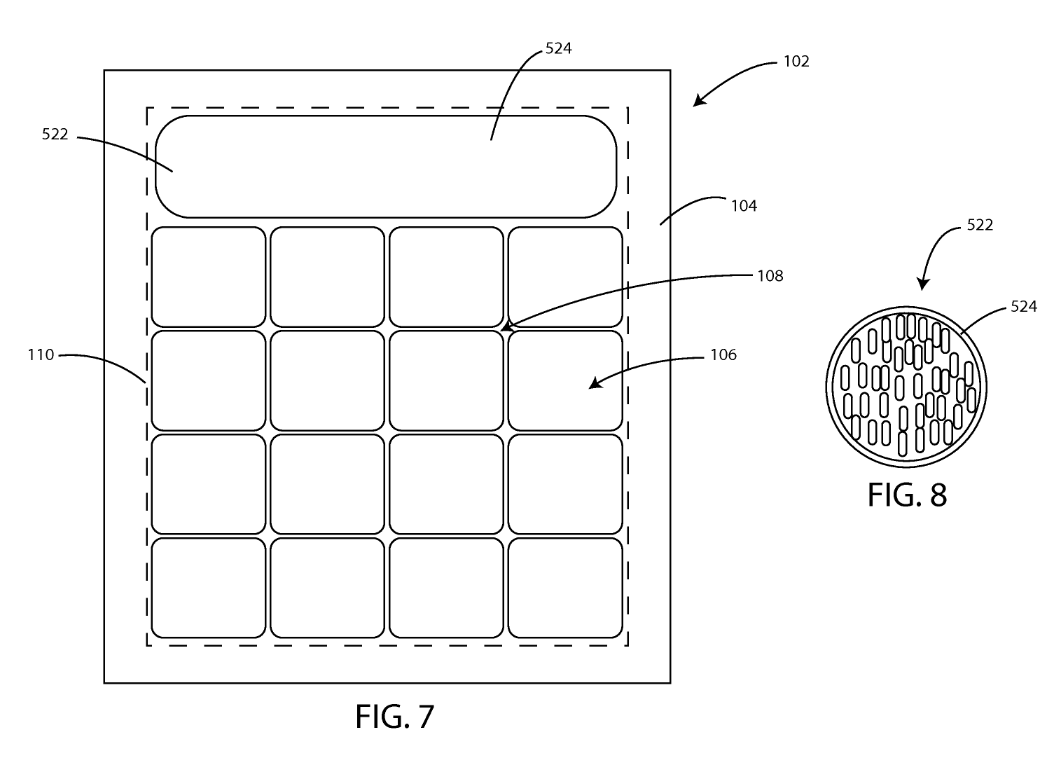

In some embodiments, an accessory device can be included with the food product in order to absorb water that may be released from the pieces of the food product when it is processed to reduce the numbers of microorganisms. Referring now to FIG. 7, the food product 102 includes a pouch 104 and a food material 106. The pouch 104 includes an interior volume 108. The food material 106 includes a plurality of pieces 110. The food product 102 can include a water absorbent accessory 522. The water absorbent accessory 522 can include a water permeable container 524. The water permeable container 524 can allow for the transport of water across the wall of the water permeable container 524 to the interior thereof where it can be absorbed or otherwise bound by an absorbent material.

Referring now to FIG. 8, a cross-sectional view of a water absorbent accessory is shown in accordance with various embodiments herein. The food product 102 shown in FIG. 8 includes a water absorbent accessory 522. The water absorbent accessory 522 can include a water permeable container wall 524. The water absorbent accessory 522 can further include a water absorbing edible material 626 disposed within the water absorbent accessory 522.

The water permeable container wall can be formed of various materials. In some embodiments, the container wall can be formed of a porous material. In some embodiments, the container wall can be formed of a material that is perforated in order to render it water permeable. The container wall can be formed of various materials including polymers, foils, cellulosic materials, and the like.

The water absorbing edible material can include a food material that absorbs water. In this manner, water that might be liberated from the discrete pieces in the food package during the sterilization or pasteurization process (or during other processing steps) can be absorbed. In some embodiments, the water absorbing edible material can be a plant product. In some embodiments, the water absorbing edible material can be a material that is high in starch. In some embodiments, the water absorbing edible material can include, but is not limited to, grains such as rice, wheat, quinoa, oats, barley, corn, amaranth, buckwheat, millet and the like. In some embodiments, the water absorbing edible material can include, but is not limited to, dried fruit or vegetables, or their peels, or legumes.

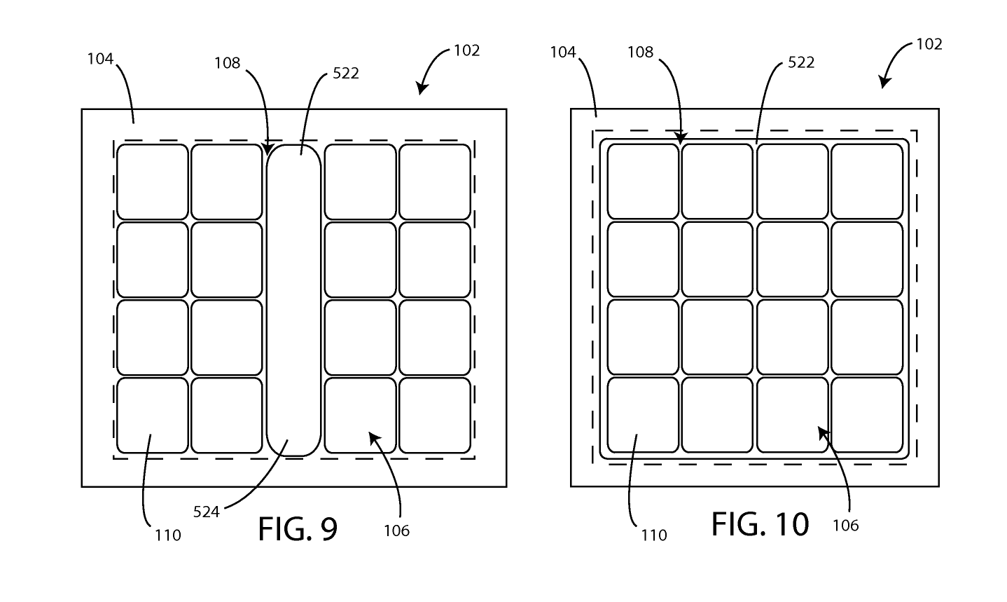

The water absorbent accessory can be configured in various ways. Referring now to FIG. 9, the food product 102 includes a pouch 104 and a food material 106. The pouch 104 includes an interior volume 108. The food material 106 includes a plurality of pieces 110. The food product 102 can include a water absorbent accessory 522. The water absorbent accessory 522 can include a water permeable container 524. In this particular configuration, the water absorbent accessory 522 is positioned near the middle of the product in terms of the overall width of the product. In this configuration, the water absorbent accessory 522 is also adjacent the top and bottom of the interior volume 108 (e.g., it extends from the top to the bottom). In some embodiments, this configuration can be advantageous because the water absorbent accessory 522 will have a portion that is immediately adjacent to the low point of the interior volume 108 where water may collect regardless of whether the product is placed and/or stored on its front, back, top, or bottom.

FIG. 10 shows yet another example of how the water absorbent accessory 522 can be configured. In this example, the food product 102 includes a pouch 104 and a food material 106. The pouch 104 includes an interior volume 108. The food material 106 includes a plurality of pieces 110. The food product 102 can include a water absorbent accessory 522 that is configured as a substantially planar structure that underlies the plurality of pieces 110.

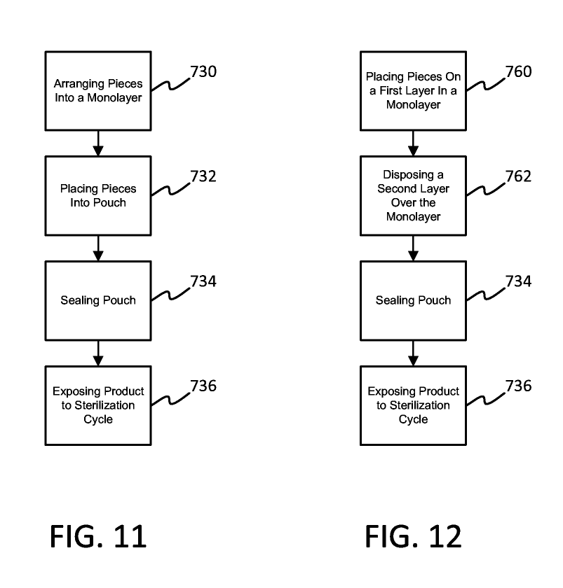

Embodiments herein can also include various methods including, but not limited to methods of making a food product, methods of processing a food product, methods of using a food product, and the like. Referring now to FIG. 11, a flow chart of a method of making a food product is shown in accordance with various embodiments herein. The method for producing a food product includes arranging pieces of a food material into a monolayer 730, placing the pieces into a pouch 732, sealing the pouch 734, and exposing the sealed pouch to a sterilization or pasteurization cycle effective to reduce the number of viable microorganisms in the food product 736. Referring now to FIG. 12, a flow chart of another method of making a food product is shown in accordance with various embodiments herein. In this embodiment, the method for producing a food product includes placing pieces of a food material arranged as a monolayer onto a first layer of a packaging material 760, disposing a second layer of a packaging material over the monolayer 762, sealing the pouch or package 734, and exposing the sealed product to a sterilization or pasteurization cycle effective to reduce the number of viable microorganisms in the food product 736. It will be appreciated that in various embodiments, a vacuum pressure can be applied to the food product before and/or during the sealing operation.

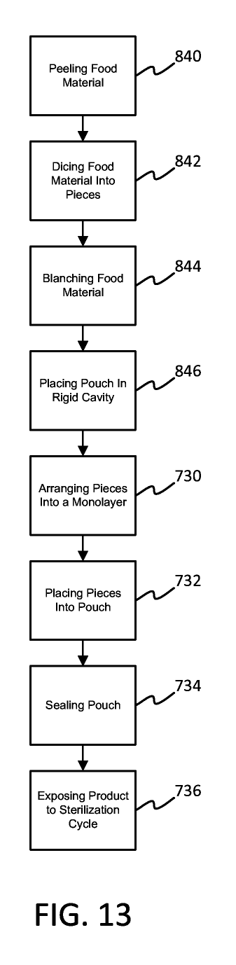

Beyond the operations shown in FIGS. 11 and 12, it will be appreciated that various additional operations can be performed in some cases. In other cases, fewer operations can be performed. Referring now to FIG. 13, the method for producing a food product includes arranging pieces of a food material into a monolayer 730, placing the pieces into a pouch 732, sealing the pouch 734, and exposing the sealed pouch to a sterilization or pasteurization cycle effective to reduce the number of viable microorganisms and/or spores in the food product 736, as before. However, in this example, the method for producing a food product can also optionally include peeling the food material 840, forming the pieces of the food product by dicing plant or animal matter into pieces 842, blanching the food material 844 where appropriate, placing the pouch in a rigid cavity 846. In some embodiments, methods herein can also include an operation of cooling and/or refrigerating the food product after exposing the sealed pouch to a sterilization or pasteurization cycle. Blanching of the food material can be performed by immersing the food material in boiling water or exposing to steam for a period of time from 0 to 30 minutes. In some embodiments, an operation of washing the food material can also be performed. In some embodiments, an operation of draining away excess water can be performed.

In some embodiments, placing the pouch in a rigid cavity is performed prior to placing the pieces into the pouch. In some embodiments, the rigid cavity is formed by two or more rigid pieces. In some embodiments, the steps of arranging pieces of a food material into a monolayer and placing the pieces into a pouch are performed simultaneously. In some embodiments, arranging pieces of a food material into a monolayer further comprises vibrating (or applying vibrational energy to) the pieces in order to help the pieces fit into place and form a monolayer.

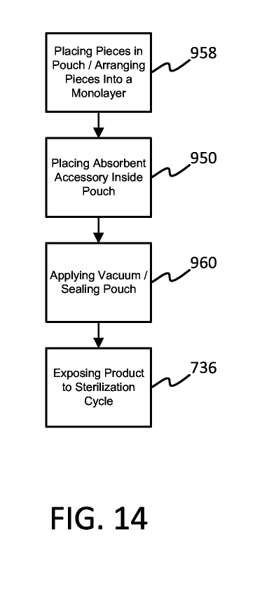

In some embodiments, the method can include a step to absorb water in the pouch. Referring now to FIG. 14, the method for producing a food product includes placing the pieces into a pouch/arranging the pieces into a monolayer 958, placing a water absorbent accessory inside of the pouch prior to sealing the pouch 950, applying a vacuum/sealing the pouch 960, and exposing the sealed pouch to a sterilization or pasteurization cycle effective to reduce the number of viable microorganisms and/or spores in the food product 736.

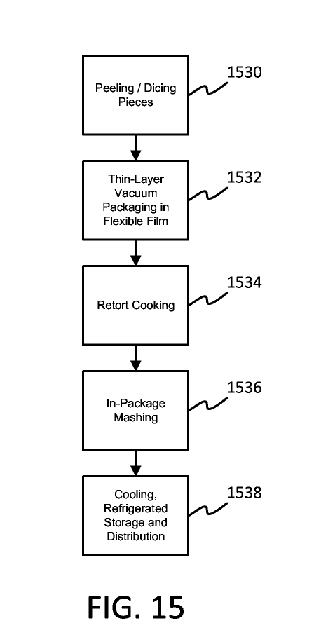

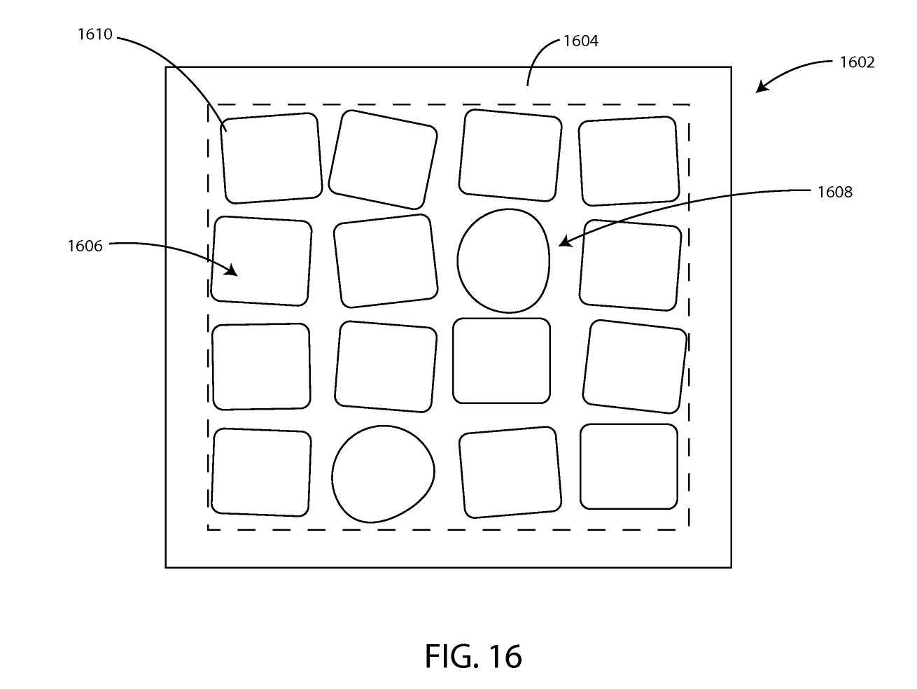

In some embodiments, the method can include a step of mashing or otherwise crushing the pieces after placement within the pouch. Referring now to FIG. 15, the method can include operations of peeling/dicing pieces 1530, thin-layer vacuum packaging in flexible film 1532, retort cooking 1534 or other sterilization or pasteurization processes, in-package mashing 1536, and cooling, refrigerating, and distribution 1538. It will be appreciated that mashing can be performed in various ways including through the use of mechanical force (such as with a roller, stomacher, press or the like), can be done ultrasonically, pneumatically, manually, or the like.

In many figures herein, such as in FIG. 1, the discrete pieces are shown in a regular pattern with uniform spacing between pieces and aligned columns and rows. However, it will be appreciated that the discrete pieces can also take on other distribution patterns such as irregular patterns with irregular spacing between pieces and patterns wherein the columns and rows of pieces are not aligned. In addition, the discrete pieces may not all have the same shape. Referring now to FIG. 16, the food product 1602 includes a pouch 1604 and a food material 1606. The pouch 1604 defines an interior volume 1608 in which the food material is disposed. The food material 1606 includes a plurality of discrete pieces 1610. In this view, the discrete pieces 1610 form a monolayer but do not have a regular pattern of spacing between pieces or precise angular arrangement of pieces one to another.

Pieces of food products herein can be of various dimensions. For purposes of reference, the pieces can all be considered to include a height, width, and thickness. In some embodiments, the thickness can be a greater than or equal to 0.25 inches and less than or equal to 1.25 inches. In some embodiments, the height can be greater than or equal to 0.25 inches and less than or equal to 12 inches. In some embodiments, the width can be greater than or equal to 0.25 inches and less than or equal to 12 inches. In some embodiments, any of these dimensions can be greater than or equal to 0.4 inches and less than or equal to 0.6 inches.

Food products herein can have a relatively high moisture content. In some embodiments, the water content (including amounts bound within the pieces) can be at least about 40% by weight. In some embodiments, the water content can be at least about 50% by weight. In some embodiments, the water content can be at least about 60% by weight. In some embodiments, the water content can be at least about 70% by weight. In some embodiments, the water content can be at least about 80% by weight. In some embodiments, the water content can be at least about 90% by weight.

In some embodiments, the plurality of pieces (as measured prior to sterilization or pasteurization) can include at least about 50 percent of the total weight of the food product. In some embodiments, the plurality of pieces (as measured prior to sterilization or pasteurization) can include at least about 60 percent of the total weight of the food product. In some embodiments, the plurality of pieces (as measured prior to sterilization or pasteurization) can include at least about 70 percent of the total weight of the food product. In some embodiments, the plurality of pieces (as measured prior to sterilization or pasteurization) can include at least about 80 percent of the total weight of the food product. In some embodiments, the plurality of pieces can include at least about 90 percent of the total weight of the food product. In some embodiments, the plurality of pieces can include at least about 100 percent of the total weight of the food product.

In some embodiments, there may a limited amount of pieces present, such as product fines or other pieces, which are not arranged in a monolayer configuration. In some embodiments, product fines can be less than or equal to 20 percent of the total weight of the food product as measured after sterilization or pasteurization. In some embodiments, the discrete pieces arranged in a monolayer can be at least about 50 percent of the total weight of the food product as measured after sterilization or pasteurization. In some embodiments, the discrete pieces arranged in a monolayer can be at least about 60 percent of the total weight of the food product as measured after sterilization or pasteurization. In some embodiments, the discrete pieces arranged in a monolayer can be at least about 70 percent of the total weight of the food product as measured after sterilization or pasteurization. In some embodiments, the discrete pieces arranged in a monolayer can be at least about 80 percent of the total weight of the food product as measured after sterilization or pasteurization. In some embodiments, the discrete pieces arranged in a monolayer can be at least about 90 percent of the total weight of the food product as measured after sterilization or pasteurization. In some embodiments, the discrete pieces arranged in a monolayer can be at least about 95 percent of the total weight of the food product as measured after sterilization or pasteurization. In some embodiments, the discrete pieces arranged in a monolayer can be at least about 98 percent of the total weight of the food product as measured after sterilization or pasteurization. In some embodiments, the discrete pieces arranged in a monolayer can be at least about 99 percent of the total weight of the food product as measured after sterilization or pasteurization.

In some embodiments, the food product overall can have a total thickness of less than about 1.25 inches. In some embodiments, the food product can have a total thickness of less than about 1.0 inches. In some embodiments, the food product can have a total thickness of less than about 0.8 inches. In some embodiments, the food product can have a total thickness of less than about 0.7 inches. In some embodiments, the food product can have a total thickness of less than about 0.6 inches.

In some embodiments, the food product overall can have a total thickness of greater than about 0.1 inches. In some embodiments, the food product can have a total thickness of greater than about 0.2 inches. In some embodiments, the food product can have a total thickness of greater than about 0.3 inches. It will be appreciated that due to some variation in the size of discrete pieces that the thickness of the package may not be uniform. Further, in some cases, two pieces may overlap one another causing a variation in thickness. As such, in some embodiments, the thicknesses references herein can refer to average thicknesses.

The pouch (or container) that holds the food product can be formed of various materials. In some embodiments the pouch can include a polymeric retortable pouch. In some embodiments, the pouch can be formed of a flexible polymeric film. In some embodiments, the pouch walls can be formed of materials including thermoplastic and/or thermoset polymers, metal foils, cellulosic materials, laminates, composites, or the like. In some embodiments, the pouch (or container) can include other structural features such as a gusseted base, a re-closable zip seal, a tear line or tear notch. In some embodiments, the pouch can be formed of a flexible polymeric film. In some embodiments, the pouch can be peelable (e.g., peel-open) or non-peelable. In some embodiments, the pouch can be clear, translucent, or opaque.

The plant or animal food material of which the pieces are formed can include various different types of plant or animal components. In some embodiments, the pieces are formed from a fruit or vegetable. The fruit or vegetable can be selected from the group consisting of potatoes, sweet potatoes, squash, pumpkin, carrots, yams, apples, mango, pears, zucchini, spinach, and the like.

Brine solutions can sometimes be added to food products prior to sterilization or pasteurization cycles to aid in heat transfer through the food product, amongst other functions. Brine solutions can be formed with various salts. By way of example, brine solution salts can include compounds that dissociate in an aqueous environment into food grade cations and anions. Brine solution salts can specifically include, but are not limited to, compounds that dissociate into sodium, potassium, magnesium, calcium as cations and chloride, carbonate, bicarbonate, or lactate as anions.

In various embodiments herein, the food product lacks a brine solution. In various embodiments, no exogenous brine solution is added to the food product prior to it being sealed in a pouch or other container. Stated differently, in various embodiments no salts are added to the food product. As such, in various embodiments, the food product includes a salt content that is substantially equal to the amount of the salt components in the discrete pieces of the food material by themselves prior to being disposed within the pouch. In various embodiments, the food product includes a salt content that is substantially equal to the amount of salts that are natively in the plant or animal food material prior to processing steps.

It will be appreciated that in various embodiments other components can be added to the food product. By way of example, food products herein can also include components such as, but not limited to, flavoring agents (including herbs, spices, flavors, sweeteners and the like), additives, preservatives, pH modifiers such as acidulants, and the like.

It will be appreciated that various parameters and conditions can be used in the course of subjecting the food product to a sterilization or pasteurization cycle. In various embodiments, the total duration of the sterilization or pasteurization cycle is less than about 45 minutes, less than 30 minutes, less than 20 minutes, less than 15 minutes, or less than 10 minutes.

In some embodiments, the sterilization or pasteurization cycle is effective to substantially reduce the number of viable microorganisms in the food product. In some embodiments, the sterilization cycle is effective to achieve commercial sterility of the food product. In some embodiments, the sterilization cycle is effective to produce a 12 log reduction in viable C. botulinum spores. In some embodiments, the sterilization cycle is effective to produce a 5 log reduction in viable C. perfringens spores. In some embodiments, the sterilization or pasteurization cycle can be divided up into a series of phases. By way of example, in some embodiments, the sterilization or pasteurization cycle can include a warm-up phase. In some embodiments, sterilization or pasteurization cycle can include a cool down phase. In some embodiments, the sterilization or pasteurization cycle can include a high pressure phase and/or a high pressure phase with high temperatures. In some embodiments, the total sterilization or pasteurization cycle time less than about 45 minutes with cooking time less than about 12 min.

### EXAMPLES

### Example 1

### Retort Processing of Monolayer Product

A sample of carrots was obtained and they were washed, peeled, and then cut into pieces of approximately 0.5 inches. These pieces were arranged in a monolayer. A thermocouple was placed within the carrot, and the carrot was subjected to conditions simulating a retort cooker. A retort cycle was initiated and the temperature inside the carrot was recorded with the thermocouple. After initially increasing the temperature to hit a target commercial sterilization temperature of 243 degrees Fahrenheit, the carrot sample was then held at a high temperature until commercial sterilization was achieved. Finally, the temperature was reduced rapidly.

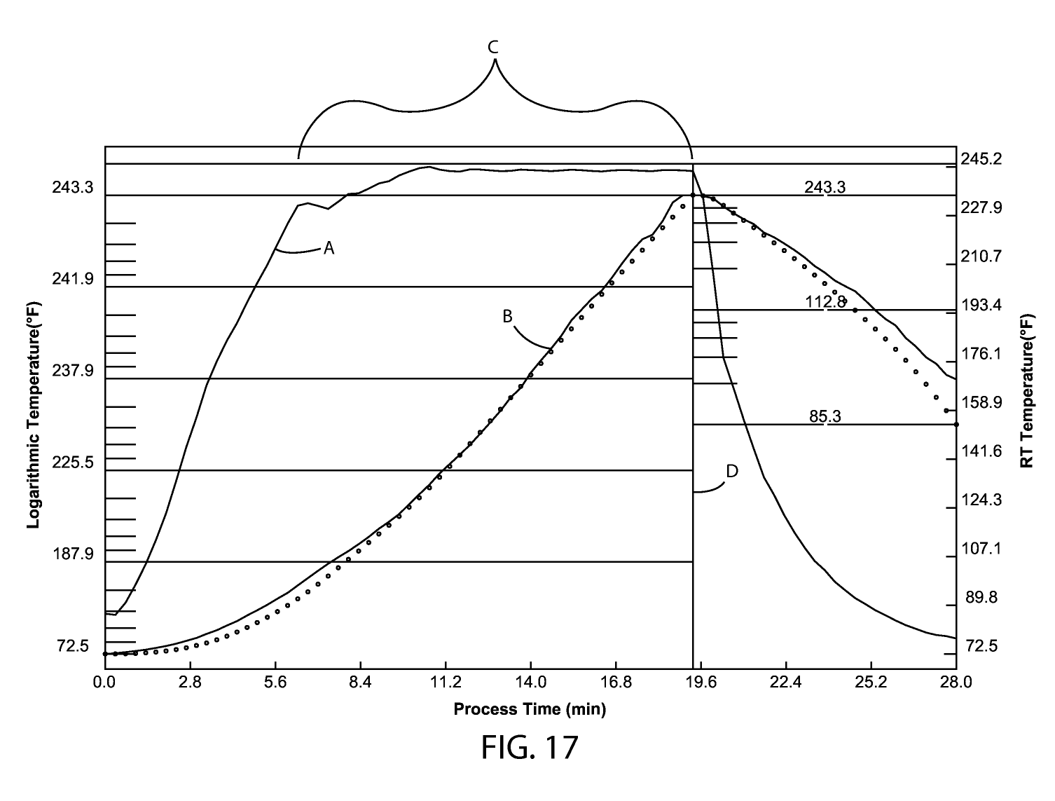

The temperature data are shown in FIG. 17. The steep curve on the left (line A) shows the temperature of the retort cooker. Zone C is represents the hold time for commercial sterilization. The flatter curve to the right (line B) shows the recorded temperature for the carrot pieces arranged as a monolayer. Vertical line D marks the point at which commercial sterilization was achieved.

The carrots arranged as a monolayer were able to achieve the target sterilization temperature much faster than the typical package and also cool down much more quickly. Visual inspection of these carrots after the sterilization cycle showed that the color of the monolayer carrots was more like a fresh color and manipulation of the carrots showed that they had a firmer texture. This example shows that monolayer food products can be processed to achieve commercial sterility without sustaining as much thermal degradation as would be experienced by otherwise similar food products that are not arranged as a monolayer.

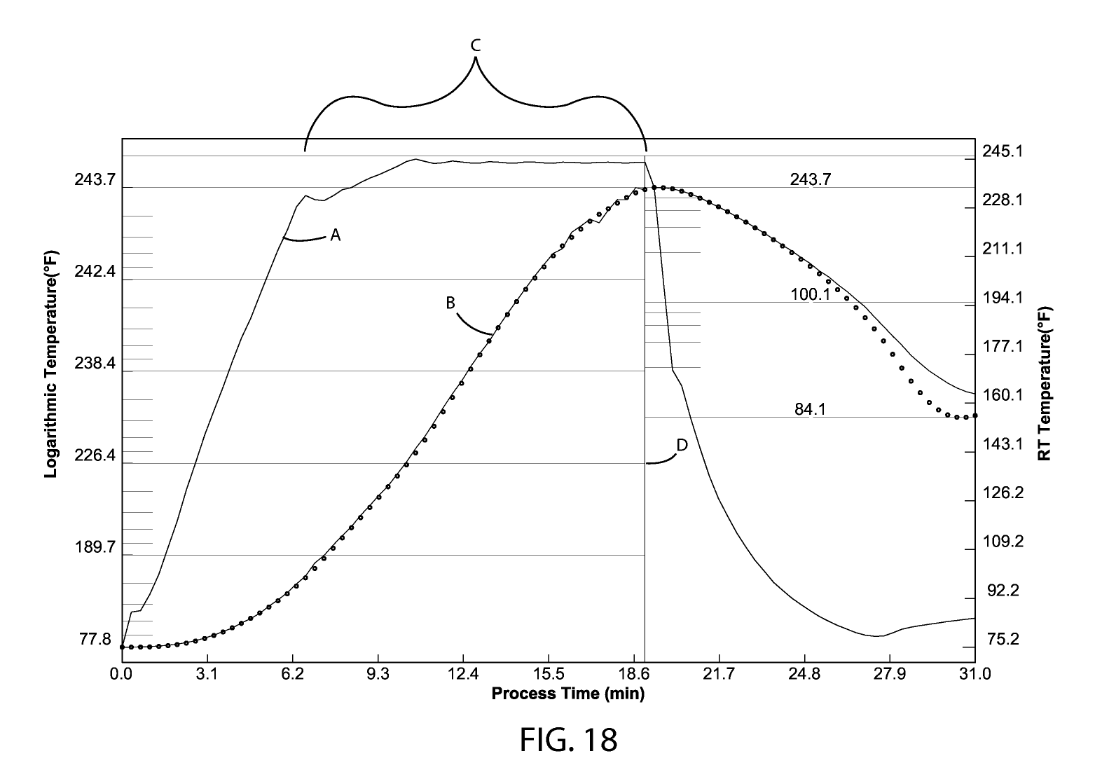

This experimental procedure was repeated for pears. The temperature data are shown in FIG. 18. The steep curve on the left (line A) shows the temperature of the retort cooker. Zone C is represents the hold time for commercial sterilization. The flatter curve to the right (line B) shows the recorded temperature for the pear pieces arranged as a monolayer. Vertical line D marks the point at which commercial sterilization was achieved. Similar to the case for carrots, the pears arranged as a monolayer were able to achieve the target sterilization temperature much faster than the typical package and also cool down much more quickly. As a result, the pears arranged as a monolayer were commercially sterilized, but sustained less thermal damage than those packaged in a typical manner.

It should be noted that, as used in this specification and the appended claims, the singular forms ‘a,’ ‘an,’ and ‘the’ include plural referents unless the content clearly dictates otherwise. Thus, for example, reference to a composition containing ‘a compound’ includes a mixture of two or more compounds. It should also be noted that the term ‘or’ is generally employed in its sense including ‘and/or’ unless the content clearly dictates otherwise.

It should also be noted that, as used in this specification and the appended claims, the phrase ‘configured’ describes a system, apparatus, or other structure that is constructed or configured to perform a particular task or adopt a particular configuration to. The phrase ‘configured’ can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

The invention has been described with reference to various specific and preferred embodiments and techniques. However, it should be understood that many variations and modifications may be made while remaining within the spirit and scope of the invention.

1. A method for producing a food product comprising:
arranging one or more discrete pieces of a food material into a monolayer inside a pouch;
sealing the pouch; and
exposing the sealed pouch to a sterilization or pasteurization cycle effective to reduce the number of viable microorganisms and/or their spores in the food product.

2. The method of claim 1, further comprising forming the pouch by placing a monolayer of one or more discrete pieces of the food material onto a first wall and then placing a second wall onto the monolayer of discrete pieces.

3. The method of claim 1, further comprising placing the pouch in a rigid cavity.

4. (canceled)

5. The method of claim 3, wherein the rigid cavity is formed by two or more rigid pieces.

6. (canceled)

7. The method of claim 1, wherein the discrete pieces arranged in a monolayer comprise at least about 60 percent of the total weight of the food product as measured after sterilization or pasteurization.

8. (canceled)

9. The method of claim 1, wherein the discrete pieces arranged in a monolayer comprise at least about 80 percent of the total weight of the food product as measured after sterilization or pasteurization.

10. (canceled)

11. The method of claim 1, the discrete pieces having a thickness, wherein the thickness is greater than or equal to 0.25 inches and less than or equal to 1.25 inches.

12. (canceled)

13. (canceled)

14. (canceled)

15. The method of claim 1, further comprising placing a water absorbent accessory inside of the pouch prior to sealing the pouch, the water absorbent accessory comprising a water absorbing edible material disposed within a water permeable container.

16. (canceled)

17. (canceled)

18. (canceled)

19. (canceled)

20. The method of claim 1, wherein the discrete pieces of the food material comprise a plant or animal food material.

21. (canceled)

22. The method of claim 1, wherein the discrete pieces of the food material comprise a fruit or vegetable selected from the group consisting of potatoes, sweet potatoes, squash, pumpkin, carrots, yams, apples, mango, pears, zucchini, and spinach.

23. The method of claim 1, further comprising applying a vacuum to the pouch prior to and/or during sealing the pouch.

24. (canceled)

25. (canceled)

26. The method of claim 1, further comprising mashing the discrete pieces after exposing the sealed pouch to a sterilization or pasteurization cycle.

27. A food product comprising:
a pouch comprising a front wall and a back wall, the front wall and the back wall attached to one another and defining an interior volume;
a food material disposed within the interior volume, the food material comprising one or more discrete pieces of a food material, the discrete pieces arranged in a monolayer between the front wall and the back wall;
the discrete pieces having a thickness, wherein the thickness is greater than or equal to 0.25 inches and less than or equal to 1.25 inches; and
the food material comprising a plant or animal food material.

28. The food product of claim 27, wherein the discrete pieces arranged in a monolayer comprise at least about 60 percent of the total weight of the food product as measured after sterilization or pasteurization.

29. (canceled)

30. The food product of claim 27, wherein the discrete pieces arranged in a monolayer comprise at least about 80 percent of the total weight of the food product as measured after sterilization or pasteurization.

31. The food product of claim 27, the discrete pieces further having a height and a width, wherein the height and width, are all greater than or equal to 0.25 inches and less than or equal to 12 inches.

32. (canceled)

33. (canceled)

34. The food product of claim 27, further a water absorbent accessory disposed inside of the pouch, the water absorbent accessory comprising a water absorbing edible material disposed within a water permeable container.

35. The food product of claim 27, wherein the discrete pieces of the food material comprise a plant or animal food material.

36. (canceled)

37. The food product of claim 27, wherein the discrete pieces of the food material comprise a fruit or vegetable selected from the group consisting of potatoes, sweet potatoes, squash, pumpkin, carrots, yams, apples, mango, pears, zucchini, and spinach.

38. The food product of claim 27, comprising a salt content that is substantially equal to the amount of salt in the discrete pieces of the food material by themselves prior to being disposed within the pouch.
